(19) United States
(12) Patent Application Publication
(10) Pub. No.: US 2019/0099028 A1
(43) Pub. Date: Apr. 4, 2019

(54) HANGING COMPARTMENTAL ACCESSORY HOLDER

(71) Applicant: Whitmor, Inc., Southaven, MS (US)

(72) Inventors: Sandy Felsenthal, Memphis, TN (US); Kristy Smith, Germantown, TN (US)

(21) Appl. No.: 16/151,413

(22) Filed: Oct. 4, 2018

Related U.S. Application Data
(60) Provisional application No. 62/568,125, filed on Oct. 4, 2017.

(51) Int. Cl. A47G 29/08; A47G 29/087

(52) U.S. Cl. CPC A47G 29/08; F16B 45/00; A47G 29/087

(57) ABSTRACT

A hanging compartmental accessory organizer that typically includes a hanging mechanism such as a hook, an optional support bar that is in communication with the hanging mechanism, a flexible back panel that is hanging from and supported by the hook and if present the support bar, at least one compartment member; wherein, the back panel comprises attachment strips, and the at least one compartment member comprising corresponding attachment means, such that the compartment member is removably attachable at multiple points on the back panel

### PREVIOUS APPLICATIONS

This application claims benefit to U.S. Patent Application No. 62/568,125, filed Oct. 4, 2017, the contents of which are incorporated herein by reference.

### BACKGROUND AND SUMMARY OF THE INVENTION

The present invention relates to an accessory organizer. More particularly, the present invention relates to a hanging compartmental accessory holder. Various types of household organizers are available, including organizers can be hung in any suitable location, such as in a closet or on a hook in the wall or on a door. However, the present invention provides more organization and flexibility. The present invention also allows the user to customize the layout to suit their organizational and usage needs.

Additionally, the present invention is easy to manufacture and easy to use.

The present invention also allows a user to be more organized when working on a project requiring multiple items. For example, with respect to a gift wrapping project, the present invention allows one to store multiple items in an organized manner, and remove certain items that are needed at a workspace as they are needed, such as bows, paper, or ribbons, for example. Since the user can have organized packages of the items they are using, this prevents the workspace from being needlessly cluttered.

Thus, a primary object of the present invention to provide an improved accessory organizer. An example of an accessory organizer of the present invention comprises a hook or hanging mechanism, a support frame, a backing or back panel, an attachment mechanism to releasably hold the compartment members against the back panel, and portable, attachable and detachable compartment members.

One embodiment of the present invention is a hanging compartmental accessory organizer that comprises a hanging mechanism, a support bar that is in communication with the hanging mechanism, a flexible back panel that is hanging from and supported by the support bar, and at least one compartment member. The back panel includes attachment strips, and the compartment members comprising corresponding attachment means, such that the compartment member is removably attachable at multiple points on the back panel.

In another embodiment, the hanging mechanism is a hook that is in communication with an inflexible support bar, and the flexible back panel is hangs from the support bar. The hook can hang over a door, for example, to support the hanging compartmental accessory organizer.

In another embodiment, the flexible back panel has a front and back surface and a hanging mechanism opening, and is draped over the support bar with the hanging mechanism opening receiving the hanging mechanism. In this embodiment, the attachment strips are attached to the front surface of the panel and the back surface simply faces the door or wall if the organizer is hanging on a wall or on a door.

In another embodiment, the flexible back panel is rectangular or generally in shape, as shown in FIG. 1, for example, It can be comprised of many different materials, and is preferably flexible and lightweight. Examples of the preferred materials include cotton, a polymeric material, or a combination of both.

In another embodiment of the present invention, the organizer comprises a plurality of compartment members. They may be of all different shapes and sizes, and because of the flexibility of the present invention, they can be removably attached to the back panel in a number of patterns. The compartment members are removably attached at multiple points on the back panel. The compartment members may also be of any number of styles. That is, the compartment members are open pockets or closable pockets.

In another embodiment of the present invention, the organizer further comprising straps that are releasably attached to the back panel to secure accessories. The straps can be used to help secure longer items such as rolls of wrapping paper.

In another embodiment, the accessory organizer includes both a plurality of compartment members that can be removably attached on multiple points of the back panel and a plurality of straps that can be removably attached on multiple points of the back panel.

In embodiments of the invention, multiple compartment members are releasably attached to the back panel. The releasable attachment feature allows for the compartment members to be attached in various arrangements. The releasable attachment feature further allows for easy and efficient attachment and reattachment of the compartment members to the backing. Of course, each compartment can be independently attached and removed.

In embodiments of the present invention, the compartment members are different shapes and sizes, and can be arranged on the back panel in a personally organized fashion.

In other embodiments of the present invention, the hanging compartmental accessory holder provides a convenient and efficient way to display and store accessories.

Another aspect of the present invention is a method of organizing materials. This method comprises a user choosing a compartment member of the present invention and placing materials in the compartments. The materials can be toys or gift wrapping materials, for example. The user can optionally choose another compartment member to place additional materials therein. The compartment members are removably attached, so they can be placed on the back panel in any arrangement desired by the user.

In other embodiments, the compartments can have openings in the top to accommodate especially elongated items. In this case, straps can be used to secure the upper portions of these items. The straps can be attachable to the back panel in generally the same manner as the compartment members. For example, hook and loop portions of the straps can engage the attachment means or attachment bands.

### BRIEF DESCRIPTION OF THE FIGURES

FIG. 1 shows a typical accessory holder (10) of the present invention hanging on a door. The embodiment depicted in this figure is shown storing items such as wrapping supplies.

FIG. 2 also shows an accessory holder (10) of the present invention hanging on a door. The embodiment depicted in this figure is shown storing household items such as umbrellas, gloves and sunglasses.

FIG. 3 also shows a typical accessory holder (10) of the present invention hanging on a door. The embodiment depicted in this figure is shown storing items such as an assortment of toys.

FIG. 4 shows a back panel (20) of an embodiment of the present invention. Shown here it includes a vertical pattern of attachment strips or bands.

FIG. 5 shows a compartment member (30) being placed in the back panel of an accessory holder of the present invention.

FIG. 6 shows a back panel (20) of an embodiment of the present invention. Shown here it includes a horizontal pattern of attachment strips or bands.

FIG. 7 shows a back panel (20) of an embodiment of the present invention. Shown here it includes a combination of a vertical and horizontal pattern of attachment strips or bands.

FIG. 8 is a perspective view of a compartment member of the present invention, mainly of the back surface. The back surface of the compartment member has an attachment means or band that corresponds with the attachment means of the back panel. This embodiment is a hook and look arrangement that allows the compartment member to be releasably attached to the back panel.

FIG. 9 shows an embodiment of the present invention that incorporates an alternative hanging mechanism compared to the one depicted in FIG. 1. This one would typically attached to the top of a door for hanging.

FIG. 10 shows an example of the hanging mechanism (15) and support bar (16) of the present invention.

### DESCRIPTION OF THE INVENTION

As stated above, an example of an accessory organizer of the present invention comprises a hook or hanging mechanism, a support frame, a backing or back panel, an attachment mechanism, and portable, attachable and detachable compartment members.

One embodiment of the present invention is a hanging compartmental accessory organizer that comprises a hanging mechanism, a support bar that is in communication with the hanging mechanism, a flexible back panel that is hanging from and supported by the support bar, and at least one compartment member. The back panel includes attachment strips, and the compartment members comprising corresponding attachment means, such that the compartment member is removably attachable at multiple points on the back panel.

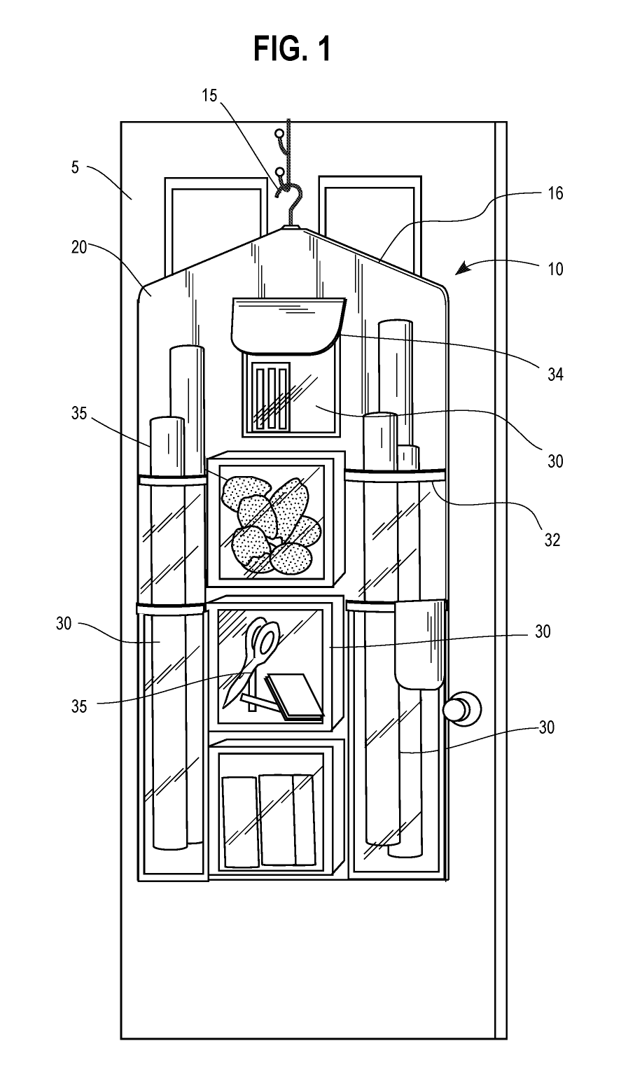

Turning to FIG. 1, which shows a front view of an embodiment of the present invention. FIG. 1 depicts an accessory holder (10) of the present invention. The hanging mechanism (15) in this embodiment is a common hook attached to a support bar (16). As depicted in the figure the accessory holder is hanging on a door (5). The backing/back panel (20) supports multiple portable compartment members (30). In this embodiment, the back panel is draped over the support bar.

The compartment members (30) may be in a variety of shapes to accommodate different accessories (35). In this embodiment, the compartment members (30) shown include those that are sack-like with the opening at the top of the compartment member. This allows for the storage of elongated members. As shown in the Figure, elongated rolls are stored. When an accessory container is holding especially elongated items such as wrapping paper rolls, umbrellas, or the like, straps (32) may be used to help secure the items. The straps are removably attached to the rear panel, usually in the same manner as the compartment members.

As is shown in the Figures, the compartment members (30) can be many shapes. For example, the compartment members may be square, rectangular, box-shaped, envelop-shaped etc. They may be open or closable. A zipper, Velcro, magnet, or a closable flap (34) that incorporates any of those can be used.

The compartment members are preferably removably attached to the backing. In one embodiment the compartment members are removable attached by using hook and loop attachments (Velcro). Additionally, as a further advantage, the removably attached compartments allows for personalized organization of the accessory holder.

This feature also allows one or more compartment members to be removed from the back panel to so that the contents can be used in a nearby working area. The compartment members can be easily replaced after use in the same or different spot following use.

For example, FIG. 1 shows an accessory container that holds gift wrapping accessories. Gift wrapping accessories in particular lends itself to using multiple items and cluttered work spaces. The present invention allows for the different materials to be organized and put away when not in use. Besides reducing work space clutter, the present invention also provides efficient and organized storage. One compartment member may be employed to house tape and scissors, while another may be employed to house ribbons and yet another may be employed to house bows. Another may be used to house wrapping paper, including elongated rolls of wrapping paper.

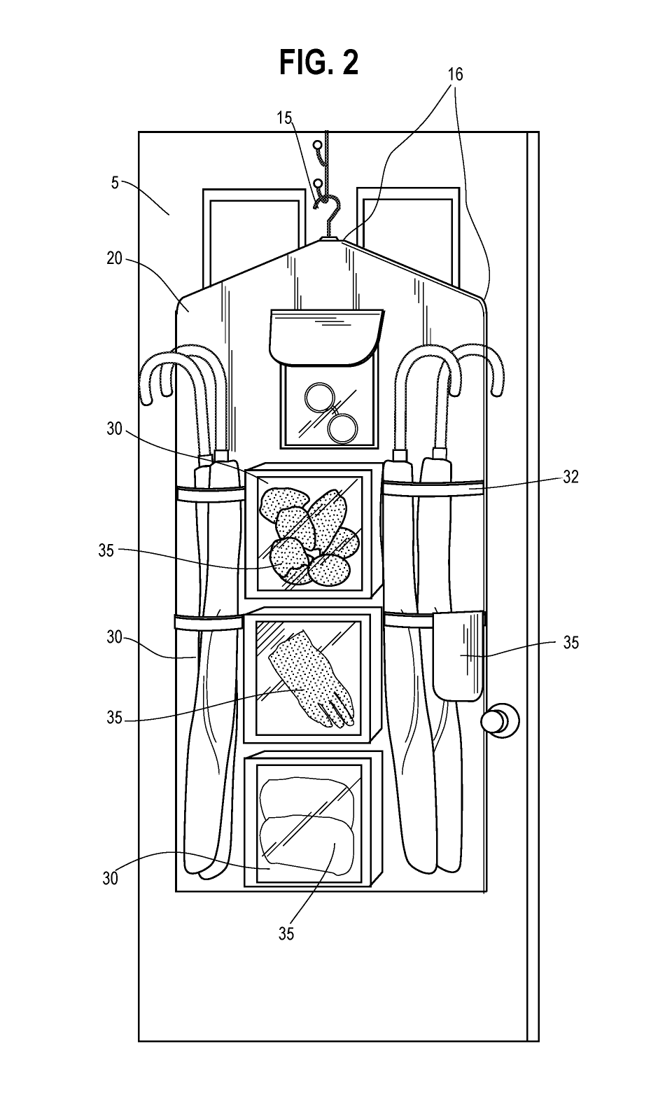

FIG. 2 shows an embodiment of the present invention that is organizing and storing a variety of accessories (35). This embodiment shows the storage and organization of various items such as sunglasses, gloves, umbrellas, etc. Although the arrangement of compartment members in FIG. 2 is substantially the same in order to show the versatility of items that can be stored, an advantage of the present invention is that the compartment members can be arranged in many different arrangements.

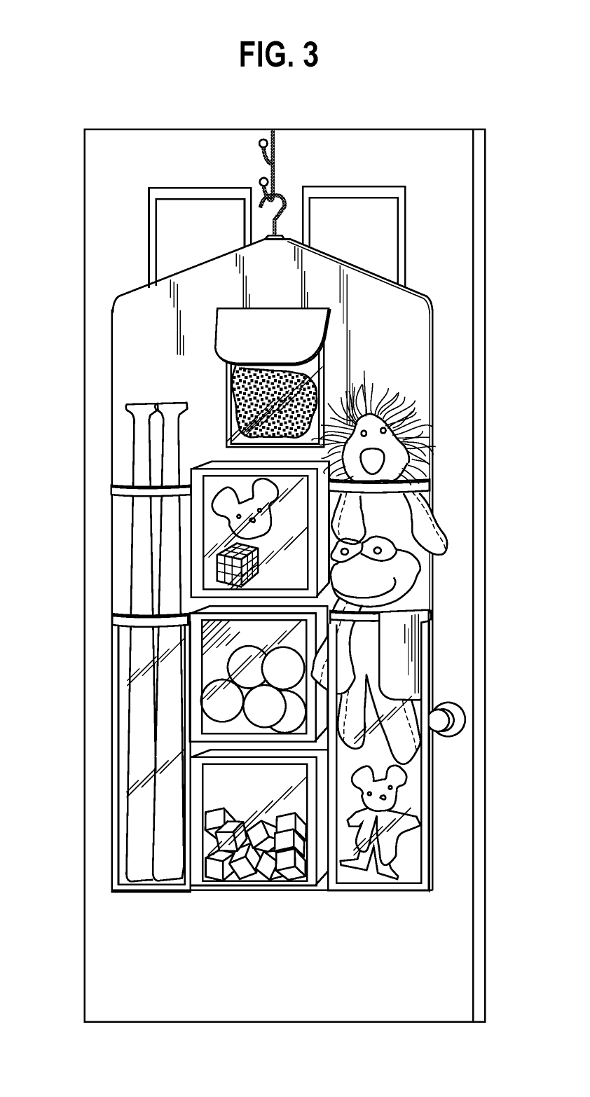

FIG. 3 shows an embodiment of the present invention that is organizing and storing a variety of toys and accessories. FIGS. 1-3 demonstrate the customability of the present invention.

In FIGS. 1-3, the hanging mechanism is a simple hook (15) attached to a back panel support bar/support frame (16). Of course, the hanging mechanism can take on many forms. One example of an alternative hanging mechanism is a loop or a plurality of loops. The hanging mechanism is used to hang the organizer from a door or wall, for example. The back panel support bar serves to provide support to the backing material. In certain embodiments, it is simply a bar or rod with sufficient stiffness to support the back panel, compartment members, and contents of the compartment members. The back panel may be draped over the support or attached in a variety of different means. FIG. 10 shows an example of the hook (15) and support bar (16) of the present invention. This arrangement allows the back panel to simply be draped over the support bar. The back panel can be comprised of a front face, back face, and an opening in the top, which simply fits over the hook.

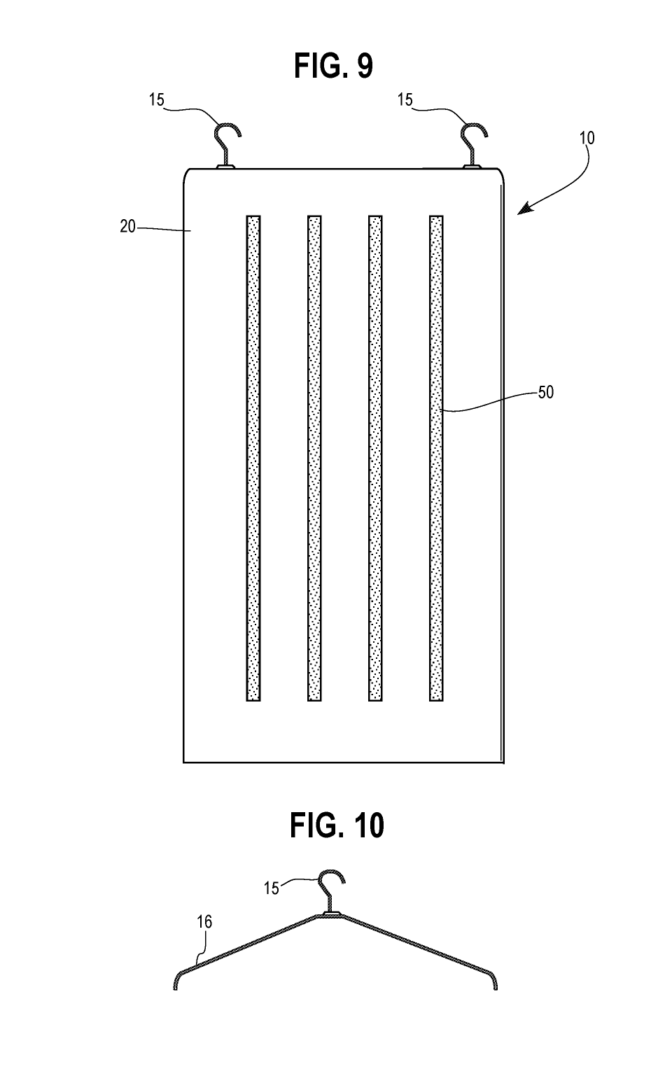

FIG. 9 shows an alternative hook arrangement that can be used to place the accessory organizer on the back of a door. In some embodiments, the hanging mechanism and/or the support bar may not be required. For example, of the back panel is of sufficient stiffness that the support bar is not required. Additionally, if the hanging mechanism is a plurality of loops the support bat may not be required, because the multiple hooks or loops may provide enough rigidity at the top of the organizer to support the back panel.

The back panel (20) may be made from a variety of material. Preferably, the back panel is flexible or semi-flexible. Having flexibility will make the present invention easier to fold for storage and/or shipping. It may be made from a canvas material, flexible plastic material, including a polyester-type material, or a natural material such as cotton. Of course, it may be a combination of materials as well. The back panel can also be a variety of thicknesses. Preferably, the back panel is simply sturdy enough to support the compartments and contents. When used in conjunction with a support, the back panel may be lighter and/or thinner.

While it can take on a variety of shapes, the backing material is generally rectangular as shown in FIGS. 1-3. This allows the present invention to hang on the back or front of a typical door.

The pockets, or compartment members (30) may be made from a variety of material as well. The compartment members shown in FIGS. 1-3 are plastic. They may have a clear or partially clear front wall or window, such as one made from clear vinyl. This embodiment allows one to easily see the contents housed in the compartments when they are attached to the back panel. The compartment members may be made from plastic, made from plastic in portion, canvas, or a natural material such as cotton. They may be the same or different material than the back panel. The compartment member may be flexible or semi flexible. The compartment members may be rigid or stiff. Additionally, the compartment members may be closable, basket-style with an open top, or a mesh-type material.

The compartment member closing mechanism may vary. The figures show a couple of the many variations. In one embodiment, they are closable with a zipper, but many different fastening devices are contemplated. A snap, stretchable top walls, slides, etc. are all contemplated. They may also have a fastenable top or closable top flap (34).

As stated above, the compartment members may also have an open end, or an open end that allows the top area of the front side to snap or fasten to the top area of the back side. The compartment members may also have an open end that simply remains open, similar to a basket or sack, to accommodate oversized items. In FIGS. 1-3, such compartments are shown housing long rolls of wrapping paper, umbrellas, toy shovels, or even baseball bats. Optional straps (32) can be employed of the items to be stored are particularly longer than the height of the compartment members. The straps can be removably attached to the back panel as well.

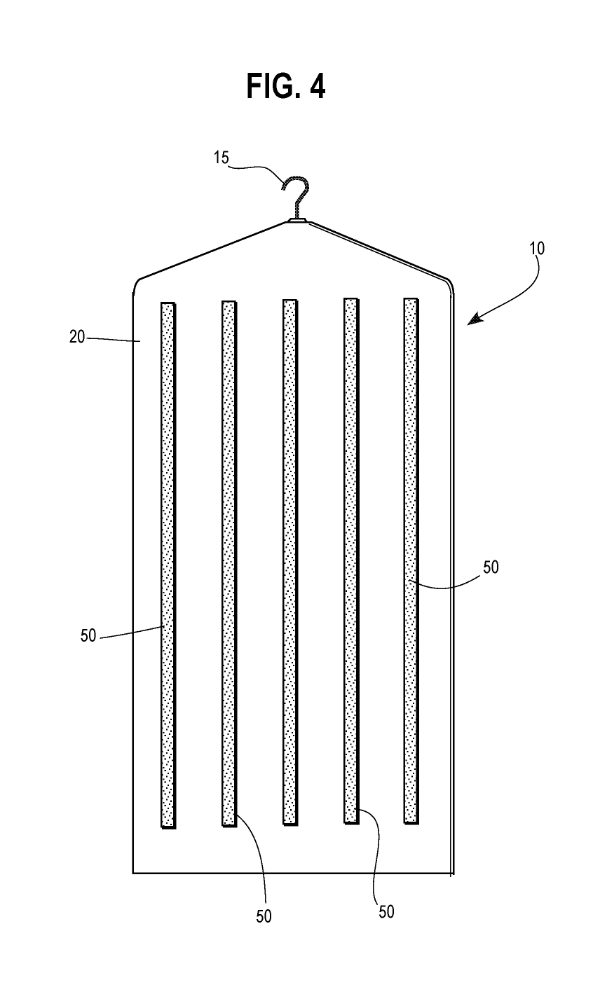

FIG. 4 shows an embodiment of the back panel (20) without the presence of the compartment members. Attached to back panel are attachment strips or bands (50). In the figure, the attachment strips are hook and loop (Velcro) strips/bands. Because of its versatility Velcro strips are preferred. The back panel will have an exposed strip of Velcro, and the back side of the compartment members will have corresponding strips or sections to allow for attachment to the back panel. Of course, for additional attachment location options, the corresponding Velcro “strip” may cover the entire back surface of the compartment members.

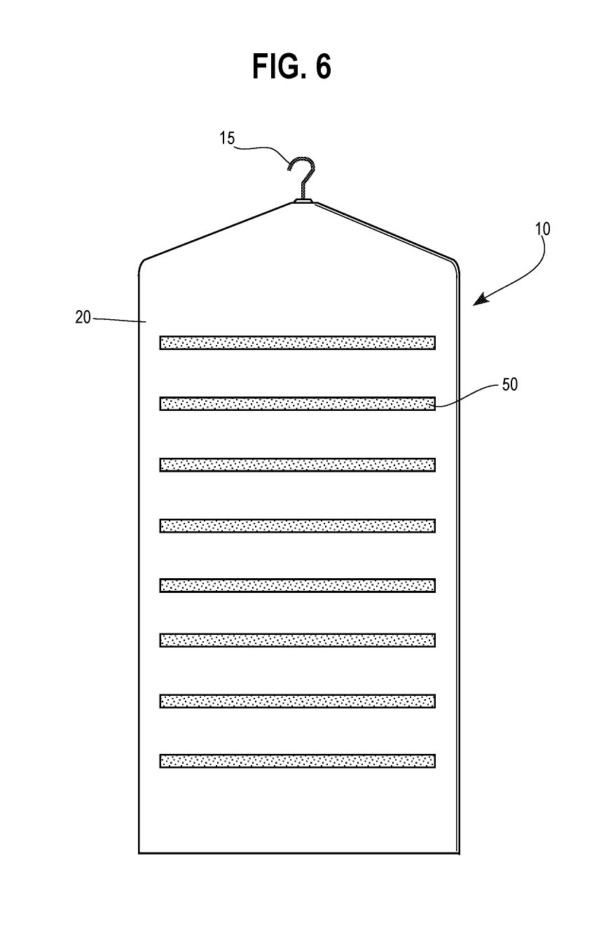

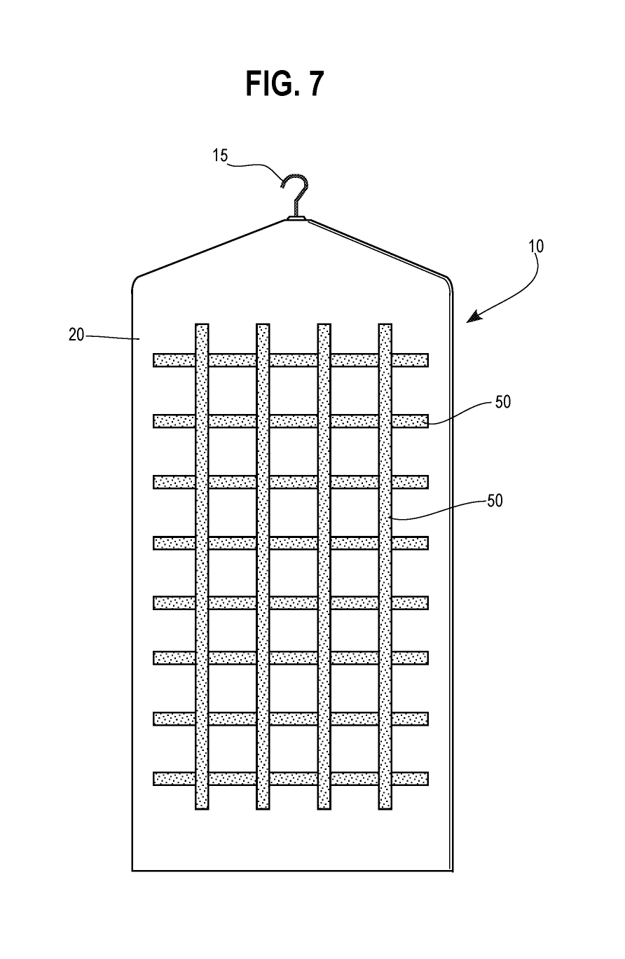

In preferred embodiments, the compartment members can be optionally attached in any number of customizable arrangements. FIG. 4 shows an embodiment of the backing (20) with a vertical arrangement of Velcro strips (50). FIG. 6 shows an embodiment of the backing (20) with a horizontal arrangement of Velcro strips (50). FIG. 7 shows an embodiment of the backing (20) with a “+” arrangement of Velcro strips (50). Additionally, diagonal, horizontal, or any combination of diagonal, horizontal, or vertical may be used. For example the bands (50) may have a diagonally crossing pattern shaped like multiple “X's.” In other embodiments, any combination of the above is contemplated.

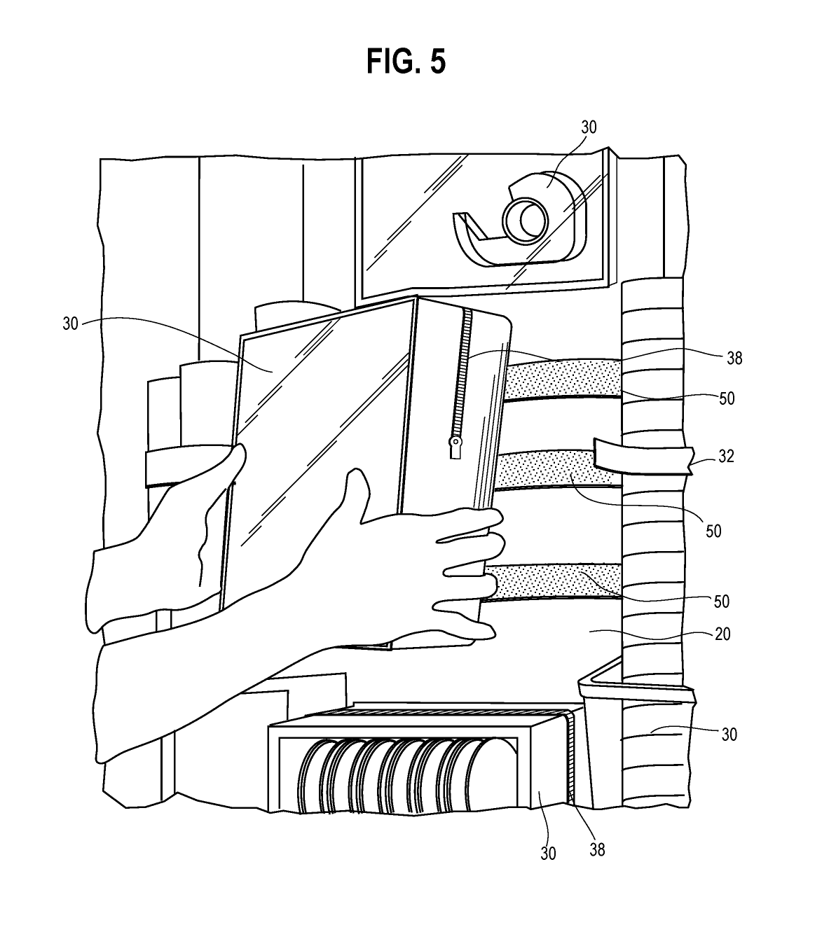

FIG. 5 shows a compartment member (30) being placed on the back panel (20). Multiple compartment members (30) are shown that are already attached to the back panel. A zipper enclosure (38) is shown. Additionally, a strap (32) for particularly elongated items is also shown. The compartmental member (30) of this embodiment has an attachment band (50) on at least a portion of its back side that corresponds with at least one attachment band on the back panel (20). This allows the compartmental member (30) to be placed along a corresponding Velcro strip (50) that is attached to the back panel.

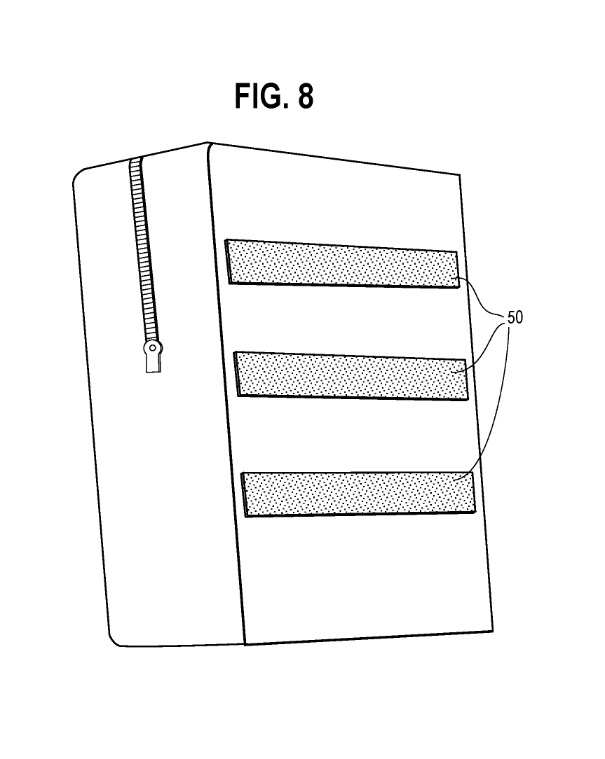

FIG. 8 is a perspective view of the panel facing side of an exemplary compartment member (30). This example is a box-shaped compartment member that is sealable with a zipper. On the back of the compartment member, attachment bands (50) are arranged so that the compartment member is easily removably attached to the back panel (20).

The invention thus being described, it would be obvious to one of ordinary skill in the art that the embodiments described herein may be modified. As such, the present invention should not be construed as being limited to the specific embodiments disclosed herein. Various modifications of the disclosed embodiments, as well as alternative embodiments of the invention will become apparent to persons skilled in the art. All such embodiment should be construed as being part of the present invention.

We claim:

1. A hanging compartmental accessory organizer, comprising:
a hanging mechanism,
a support bar that is in communication with the hanging mechanism,
a flexible back panel that is hanging from and supported by the support bar,
at least one compartment member;
wherein, the back panel comprises attachment strips, and the at least one compartment member comprising corresponding attachment means, such that the compartment member is removably attachable at multiple points on the back panel.

2. The hanging compartmental accessory organizer of claim 1, wherein the hanging mechanism is a hook that is in communication with an inflexible support bar; and
the flexible back panel hangs from the support bar.

3. The hanging compartmental accessory organizer of claim 1, wherein the flexible back panel has a front and back surface and a hanging mechanism opening, and is draped over the support bar with the hanging mechanism opening receiving the hanging mechanism; and
wherein the attachment strips are attached to the front surface.

4. The hanging compartmental accessory organizer of claim 1, wherein the flexible back panel is rectangular in shape and is comprised of cotton, a polymeric material, or a combination of both.

5. The hanging compartmental accessory organizer of claim 1, comprising a plurality of compartment members.

6. The hanging compartmental accessory organizer of claim 5, wherein the plurality of compartment members are removably attached at multiple points on the back panel.

7. The hanging compartmental accessory organizer of claim 5, wherein the compartment members are different sizes.

8. The hanging compartmental accessory organizer of claim 5, wherein the compartment members are open pockets or closable pockets.

9. The hanging compartmental accessory organizer of claim 1, further comprising straps that are releasably attached to the back panel to secure accessories.

10. The hanging compartmental accessory organizer of claim 1, comprising:
a plurality of compartment members that can be removably attached on multiple points of the back panel;
a plurality of straps that can be removably attached on multiple points of the back panel.

11. The hanging compartmental accessory organizer of claim 1, wherein:
the flexible back panel is generally rectangular in dimension with a top end and a bottom end, and the attachment strips extend vertically along the back panel.

12. The hanging compartmental accessory organizer of claim 1, wherein:
the flexible back panel is generally rectangular in dimension with a top end and a bottom end, and the attachment strips extend at least one of vertically, horizontally, or both, along the back panel.

13. The hanging compartmental accessory organizer of claim 1, wherein the compartment members have are at least partially clear to allow any contents to be viewed from outside the container.

14. The hanging compartmental accessory of claim 5, wherein at least one compartment member has an open end.

15. The hanging compartmental accessory of claim 1, the compartment member has front face and a back face, with the back face comprising ant attachment strip that is releasably attached to the back panel.

16. The hanging compartmental accessory of claim 15, wherein at least a portion of the front face is clear to allow contents to be viewed from outside the compartment member.
